(19) United States
(12) Patent Application Publication
(10) Pub. No.: US 2010/0033601 A1
(43) Pub. Date: Feb. 11, 2010

(54) SOLID-STATE IMAGING DEVICE WITH A SENSOR CORE UNIT AND METHOD OF DRIVING THE SAME

(76) Inventors: Takahiro MATSUDA, Kawasaki-shi (JP); Kenichi Arakawa, Fujisawa-shi (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/536,672

(22) Filed: Aug. 6, 2009

(30) Foreign Application Priority Data
Aug. 8, 2008 (JP) 2008-205533

(51) Int. Cl. H04N 5/217; H04N 5/335

(52) U.S. Cl. 348/241; 348/308; 348/E05.091

(57) ABSTRACT

A solid-state imaging device includes a plurality of pixel units, a reference voltage generator circuit, a cancellation unit, an analog-to-digital converter unit, a latch circuit, and a video processing unit. The plurality of pixel units output a reset signal serving as a first reference level of a video signal and the video signal, the video signal being output in units of two or more of the pixel units simultaneously to two or more of the signal lines. The reference voltage generator circuit generates a clamp voltage. The cancellation unit calculates the difference between a first addition and a second addition. The analog-to-digital converter unit digitizes the subtraction result. A latch circuit latches the result obtained at the analog-to-digital converter unit. The video processing unit terminates and starts the signal process in units of the pixel unit in a period when the clamp voltage is not generated.

### CROSS-REFERENCE TO RELATED APPLICATIONS

This application is based upon and claims the benefit of priority from prior Japanese Patent Application No. 2008-205533, filed Aug. 8, 2008, the entire contents of which are incorporated herein by reference.

### BACKGROUND OF THE INVENTION

1. Field of the Invention

This invention relates to a solid-state imaging device and a method of driving the same, and more particularly to the operation timing of a sensor core unit.

2. Description of the Related Art

A CMOS image sensor includes a pixel unit, a reference voltage generator circuit, a noise cancellation circuit, an analog-to-digital converter, a latch circuit, a video processing unit, and an output terminal. The pixel unit photoelectrically converts a received optical signal and then accumulates the charges obtained by the photoelectric conversion. The reference voltage generator circuit generates a reference voltage for analog-to-digital conversion and a dark-period clamp voltage to constantly output a specific digital signal in a dark period. The noise cancellation circuit eliminates noise included in a video signal. The analog-to-digital converter circuit digitizes an analog signal corresponding to the video signal from which noise has been removed. The latch circuit latches the video signal digitized by the analog-to-digital converter. Lastly, the video processing unit carries out a desired image signal process. The video signal output from the video processing unit is output to the outside via an output terminal.

Previously, to prevent noise produced by a synchronization signal or a color synchronization signal in the horizontal blanking period from mixing in a digital video output signal, a line memory for temporarily holding the digital signal output from the video processing unit was further provided, thereby shifting the output timing of the line memory. By doing this, pattern noise and random noise were reduced as disclosed in Jpn. Pat. Appln. KOKAI Publication No. 2006-42033.

As more and more pixels have recently been used, the number of video signals output collectively has been increasing as compared in the past. When the intensity of the video signal changed significantly, noise was generated at the video processing unit which processed the video signal. Moreover, when outputting the video signal, the video processing unit also generated noise, which resulted in a drop in the dark-period clamp voltage and in the reference voltage used for analog-to-digital conversion.

Conversely, when a change in the intensity of the video signal was small, the dark-period clamp voltage and reference voltage rose. That is, the dark-period output clamp voltage and reference voltage fluctuated, depending on the video signal.

### BRIEF SUMMARY OF THE INVENTION

A solid-state imaging device according to an aspect of the invention include,

a plurality of pixel units which output to individual signal lines a reset signal serving as a first reference level of a video signal according to a reset voltage and the video signal according to the reset voltage and the charge obtained by photoelectric conversion, the video signal being output in units of two or more of the pixel units simultaneously to two or more of the signal lines;

a reference voltage generator circuit which generates a dark-period output clamp voltage serving as a second reference level of the video signal;

a cancellation unit which calculates the difference between a first addition result by adding the reset signal output to the signal lines and the dark-period output clamp voltage and a second addition result by adding the video signal and the dark-period output clamp voltage;

an analog-to-digital converter unit which digitizes the subtraction result;

a latch circuit which latches the result of digitization obtained at the analog-to-digital converter unit; and

a video processing unit which subjects the result of digitization transferred from the latch circuit to a signal process, the video processing unit terminating and starting the signal process in units of the pixel unit in a period when the dark-period output clamp voltage is not generated.

A method of driving a solid-state imaging device according to an aspect of the invention include,

causing a plurality of pixel units to output a reset signal serving as a first reference level of a video signal to signal lines according to a reset voltage, the video signal being output in units of two or more of the pixel units simultaneously to two or more of the signal lines;

generating a dark-period output clamp voltage serving as a second reference level of the video signal;

obtaining a first addition result by adding the reset signal output to the signal lines and the dark-period output clamp voltage;

after the reset signal is output to the signal lines, causing the pixel units to output the video signal to the signal lines according to the reset voltage and the charge obtained by photoelectric conversion;

obtaining a second addition result by adding the video signal output to the signal lines and the dark-period output clamp voltage;

calculating the difference between the first addition result and the second addition result;

digitizing the difference and transferring the result of digitization to a video processing unit and

causing the video processing unit to carry out a signal process using the transferred result of digitization, the video processing unit terminating and starting the signal process in units of the pixel unit in a period when the dark-period output clamp voltage is not generated.

### BRIEF DESCRIPTION OF THE SEVERAL VIEWS OF THE DRAWING

FIG. 1 is a block diagram showing the configuration of a solid-state imaging device (or CMOS image sensor) according to a first embodiment of the invention;

FIG. 2 is a circuit diagram of a sensor core unit according to the first embodiment;

FIG. 3 is a timing chart to explain the operation of the solid-state imaging device according to the first embodiment;

FIG. 4 is a timing chart to explain the operation of a conventional solid-state imaging device;

FIG. 5 is a timing chart to explain the operation of a solid-state imaging device according to a modification of the first embodiment;

FIG. 6 is a timing chart to explain the operation of a solid-state imaging device according to a second embodiment of the invention; and

FIG. 7 is a timing chart to explain the operation of a solid-state imaging device according to a modification of the second embodiment.

### DETAILED DESCRIPTION OF THE INVENTION

Hereinafter, referring to the accompanying drawings, embodiments of the invention will be explained. Like parts are shown by corresponding reference numerals throughout the drawings.

### First Embodiment

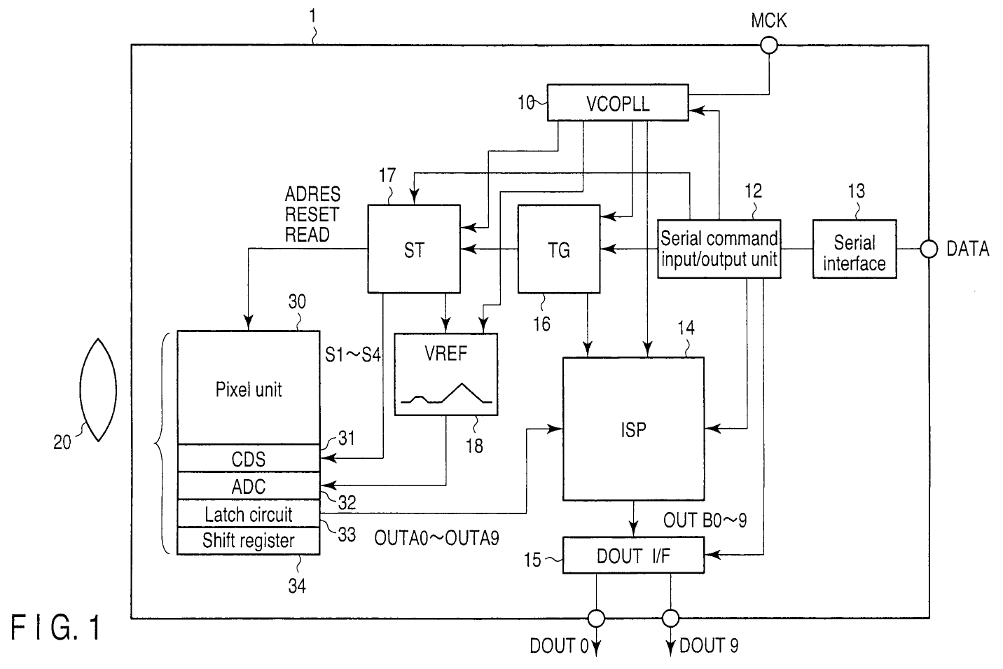

A solid-state imaging device according to a first embodiment of the invention and a method of driving the imaging device will be explained using FIG. 1. FIG. 1 shows a configuration of the solid-state imaging device of the first embodiment. An explanation will be given using a CMOS image sensor as an example.

As shown in FIG. 1, the solid-state imaging device 1 comprises a clock control circuit 10 (hereinafter, referred to as the VCOPLL 10), a serial command input-output unit 12, a serial interface 13, a video signal processing circuit 14 (hereinafter, referred to as the ISP 14), a data output interface 15 (hereinafter, referred to as the DOUT 15), a reference timing generator circuit 16 (hereinafter, referred to as the TG 16), a sensor drive timing generator circuit 17 (hereinafter, referred to as the ST 17), a reference voltage generator circuit 18, a sensor core unit 19, and a lens 20. The sensor core unit 19 includes not only a pixel unit 30 but also a noise cancellation circuit 31 (hereinafter, referred to as the CDS 31), an analog-to-digital converter circuit 32 (hereinafter, referred to as the ADC unit 32), a latch unit 33, and a horizontal shift register 34 which are provided under the pixel unit 30. Hereinafter, each of them will be explained in detail.

The VCOPLL 10 generates an internal clock of the solid-state imaging device 1 on the basis of a clock signal supplied from a master clock MCK. The master clock MCK is a clock signal obtained on the basis of, for example, a clock provided outside the solid-state imaging device 1 (hereinafter, referred to as an external clock). The count speed frequency of the internal clock is controlled by the VCOPLL 10.

The serial interface 13 externally receives control data for operating the overall system of the solid-state imaging device 1 including the ISP 14. The control data includes, for example, commands and the operation timing for operating the overall system. The serial interface 13 supplies control data received from the outside to the serial command input-output unit 12.

The serial command input-output unit 12 controls each of the VCOPLL 10, TG 16, ISP 14, and DOUT 15 on the basis of the control data, thereby supervising the operation of the entire solid-state imaging device 1.

On the basis of the control data supplied from the serial command input-output unit 12, the TG 16 gives an instruction to each of the ST 17 and ISP 14, thereby controlling the operation of each of the sensor core unit 19 and ISP 14. That is, the TG 16 instructs each of the ISP 14 that drives a video signal process and the ST 17 that controls the operation timing of the sensor core unit 19 on operation timing. Specifically, after the sensor core unit 19 having accumulated the charges obtained by the photoelectric conversion, the TG 16 instructs the ST 17 on the timing of reading the charges, the timing of digitizing the read video signal, the timing of transferring the video signal to the ISP 14, and the like. At the same time, the TG 16 supplies to the ISP 14 the timing with which the sensor core unit 19 transfers the video signal, the timing of outputting the video signal to the DOUT 15, and the like.

With the operation timing supplied from the TG 16, the ST 17 supplies to the sensor core unit 19 a vertical line selection pulse (hereinafter, referred to as signal ADRES), a detection unit reset pulse (hereinafter, referred to as signal RESET), a signal read pulse (hereinafter, referred to as signal READ), and switch signals S1 to S4. Each of signal ADRES, signal RESET, signal READ, and switch signals S1 to S4 is at, for example, either low or high.

The ST 17 instructs the reference voltage generator circuit 18 on a triangular-wave reference voltage VREF used for analog-to-digital conversion and on the operation timing of generating a dark-period output clamp voltage serving as a reference for the video signal read from the pixel unit 30.

The reference voltage generator circuit 18 generates a triangular-wave reference voltage VREF and dark-period output clamp voltage with the operation timing supplied from the ST 17 and supplies the generated voltages to the ADC unit 32.

The sensor core unit 19 includes a plurality of pixels (hereinafter, referred to as pixels) arranged in a matrix. Specifically, on the basis of signal ADRES, signal RESET, and signal READ supplied from the ST 17, the pixel unit 30 subjects the pixels to a reset operation or a pixel selection operation and reads a video signal from the selected pixels. In the reset operation, the pixel unit 30 supplies the reset level from the pixel unit 30 to the CDS 31. The reset level will be explained later.

Using the dark-period output clamp voltage supplied from the reference voltage generator circuit 18 and reset-level voltage, the CDS 31 cancels noise included in the video signal read from the pixel unit 30.

The ADC unit 32 subjects the noise-cancelled video signal to analog-to-digital conversion, producing a 10-bit digital signal.

The latch unit 33 latches the digital signal obtained at the ADC unit 32.

The horizontal shift register 34 gives an instruction to read the digital signal latched in the latch unit 33.

With the timing supplied from the TG 16, the ISP 14 subjects the digital signal supplied from the sensor core unit 19 to video signal processes, including a white balance process, a wide dynamic range process, a noise reduction process, and a bad pixel correction process. Then, the ISP 14 outputs the digital signal subjected to the video signal process as signal OUTB.

The DOUT 15 outputs the digital signal subjected to the video signal process at the ISP 14 as signal DOUT outside the solid-state imaging device 1.

As described above, the latch unit 33 transfers a 10-bit digital signal to the ISP 14. Thereafter, having received the 10-bit digital signal from the latch unit 33, the ISP 14 carries out the video signal process and then outputs the resulting 10-bit digital signal. Hereinafter, let the digital signal transferred from the latch unit 33 to the ISP 14 be signal OUTA, the digital signal transferred from the ISP 14 to the DOUT 15 be signal OUTB, and the digital signal output from the DOUT 15 be signal DOUT (in FIG. 1, OUTA0 to OUTA9, OUTB0 to OUTB9, DOUT0 to DOUT9). Signal OUTA, signal OUTB, and signal DOUT are output in parallel.

The lens 20 receives light from the outside, causes the received light to pass through a resolution filter, and supplies the resulting light to the pixel unit 30. The filter resolves light into RGB components.

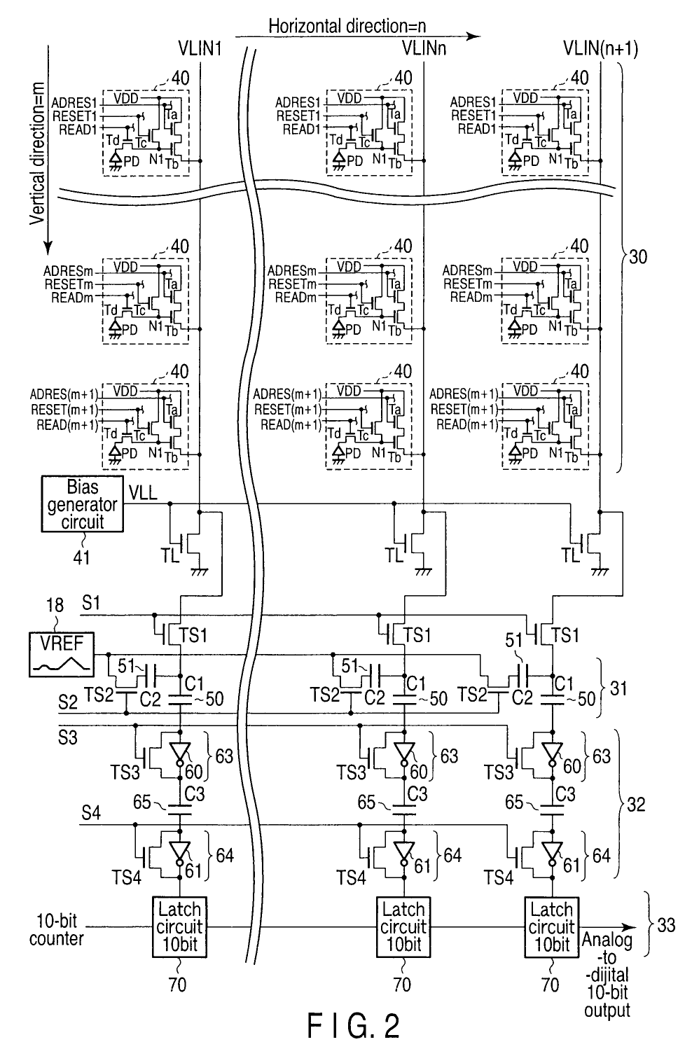

Next, the details of the sensor core unit 19 will be explained with reference to FIG. 2. FIG. 2 is a circuit diagram of the sensor core unit 19.

<About Pixel Unit 30>

As shown in FIG. 2, in the pixel unit 30, pixels 40 connected to a plurality of vertical signal lines VLIN in a one-to-one correspondence are provided so as to form (m+1) rows of pixels in the vertical direction. That is, the pixel unit 30 includes a plurality of pixels 40 arranged in a matrix. To each of the vertical signal lines VLIN, a MOS transistor TL, a MOS transistor TS1, a CDS 31, an ADC unit 32, and a latch unit 33 are connected. Hereinafter, with vertical signal line VLIN1 in mind, a pixel 40 provided on a first horizontal line perpendicular to the vertical signal lines VLIN will be explained.

A pixel 40 includes MOS transistors Ta, Tb, Tc, and Td and a photodiode PD.

Signal ADRES1 supplied from the ST 17 (not shown) is supplied to the gate of MOS transistor Ta. A voltage VDD (e.g., 2.8 V) is applied to the drain of MOS transistor Ta. That is, MOS transistor Ta functions as a select transistor. Signal RESET1 supplied from the ST 17 (not shown) is supplied to the gate of MOS transistor Tc. A voltage VDD is applied to the drain of MOS transistor Tc. The source of MOS transistor Tc is connected to a connection node N1. That is, MOS transistor Tc functions as a reset transistor. Signal READ1 supplied from the ST 17 (not shown) is supplied to the gate of MOS transistor Td. The drain of MOS transistor Td is connected to the connection node N1. The source of MOS transistor Td is connected to the cathode of the photodiode PD. That is, MOS transistor Td functions as a signal charge read transistor. The anode of the photodiode PD is grounded.

The connection node N1 is connected to the gate of MOS transistor Tb. The drain of MOS transistor Tb is connected to the source of MOS transistor Ta. The source of MOS transistor Tb is connected to vertical signal line VLIN1. That is, the gate of MOS transistor Tb, the source of MOS transistor Tc, and the drain of MOS transistor Td are connected in common at the connection node N1. The connection node N1 is used as a node where a potential is detected. The node is referred to as a detection unit N1. The MOS transistor Tb functions as an amplifying transistor.

The signal lines that transmit signal ADRES1, signal RESET1, and signal READ1 are connected in common at the pixels 40 provided on the first horizontal line perpendiculars to the vertical signal lines VLIN. That is, the signal lines are connected in common to the pixels 40 which are on the first horizontal line perpendicular to the vertical signal lines VLIN and connected to vertical signal line VLIN1 to vertical signal line VLIN(n+1) in a one-to-one correspondence. The same holds true for a second to a (m+1)-th horizontal line perpendicular to the vertical signal lines VLIN.

The pixels 40 arranged in the same column are connected in common to any one of vertical signal line VLIN1 to vertical signal line VLIN(n+1) via the source of MOS transistor Tb. Hereinafter, when vertical signal line VLIN1 to vertical signal line VLIN(n+1) are not distinguished from one another, they are just referred to as the vertical signal lines VLIN. Here, n is a natural number.

To the pixels 40 in the same row, any one of signal ADRES1 to signal ADRES(m+1), signal RESET1 to signal RESET(m+1), and signal READ1 to signal READ(m+1) is supplied in common. Hereinafter, when signal ADRES1 to signal ADRES(m+1), signal RESET1 to signal RESET(m+1), and signal READ1 to signal READ(m+1) are not distinguished from one another, they are simply referred to as the signals ADRES, signals RESET, and signals READ, respectively. Here, m is a natural number.

The drain of MOS transistor TL is connected to one end of the vertical signal line VLIN. A voltage VLL from the voltage generator circuit 41 is applied to the gate of MOS transistor TL. The source of MOS transistor TL is grounded. The voltage VLL output from the voltage generator circuit 41 is applied to the gates of all the MOS transistors TL corresponding to vertical signal line VLIN1 to vertical signal line VLIN(n+1). MOS transistor TL and MOS transistor Tb form a source-follower circuit. A switch signal S1 from the ST 17 (not shown) is supplied to the gate of MOS transistor TS1. The drain of MOS transistor TS1 is connected to the drain of the MOS transistor TL. The source of MOS transistor TS1 is connected to a corresponding CDS31. Switch signal S1 is supplied to each of the gates of MOS transistors TS1 corresponding to the vertical signal lines VLIN.

<About the Configuration of CDS 31>

Next, the details of the CDS 31 will be explained. In the CDS 31, capacitor elements 50, 51 and MOS transistor TS2 are provided for each of the vertical signal lines VLIN. The source of MOS transistor TS1 is connected to one electrode of the capacitor element 50. Similarly, the source of MOS transistor TS1 is connected to one electrode of the capacitor element 51. That is, one electrode of the capacitor element 50 and that of the capacitor element 51 are connected in common. The other electrode of the capacitor element 51 is connected to the source of MOS transistor TS2. Either the triangular-wave reference voltage VREF generated by the reference voltage generator circuit 18 or the dark-period output clamp voltage generated by the reference voltage generator circuit 18 is applied to the drain of MOS transistor TS2. Switch signal S2 from the ST 17 is supplied to the gate of MOS transistor TS2. The output voltage of the reference voltage generator circuit 18 is supplied to the drain of MOS transistor TS2 corresponding to each of the vertical signal lines VLIN. Switch signal S2 is supplied to the gate of MOS transistor TS2 corresponding to each of the vertical signal lines VLIN. Since switch signal S2 is constantly high, MOS transistor TS2 constantly remains in the on state. That is, the ST 17 applies the triangular-wave reference voltage VREF and the dark-period output clamp voltage generated by the reference voltage generator circuit 18 to the capacitor element 50, 51, respectively, via MOS transistor TS2.

<About the Configuration of ADC Unit 32>

Next, the configuration of the ADC unit 32 will be explained in detail. The ADC unit 32 includes inverter INV 60 (hereinafter, referred to as INV 60), inverter INV 61(hereinafter, referred to as INV 61), MOS transistor TS3, MOS transistor TS4, and a capacitor element 65 for each of the vertical signal lines VLIN.

The other electrode of the capacitor element 50 is connected to the input end of INV 60. One electrode of the capacitor element 65 is connected to the output end of INV 60. A switch signal S3 from the ST 17 is supplied to the gate of MOS transistor TS3. The other electrode of the capacitor element 50 is connected to the drain of MOS transistor TS3. The output end of INV 60 is connected to the source of MOS transistor TS3. That is, the other electrode of the capacitor element 50 and the drain of MOS transistor TS3 are connected in common. One electrode of the capacitor element 65 and the source of MOS transistor TS3 are connected in common. Then, INV 60 and MOS transistor TS3 function as a comparator COMP 63. Switch signal S3 is supplied to the gate of MOS transistor TS3 corresponding to each of the vertical signal lines VLIN. Accordingly, if MOS transistor TS3 is on, negative feedback is applied to COMP 63.

The other electrode of the capacitor element 65 is connected to the input end of INV 61. A switch signal S4 from the ST 17 is supplied to the gate of MOS transistor TS4. The other electrode of the capacitor element 65 is connected to the drain of MOS transistor TS4. The output end of INV 61 is connected to the source of MOS transistor TS4. That is, the other electrode of the capacitor element 65 and the drain of MOS transistor TS4 are connected in common. The output end of INV 61 and the source of MOS transistor TS4 are connected in common. INV 61 and MOS transistor TS4 function as a comparator COMP 64. Switch signal S4 is supplied to the gate of MOS transistor TS4 corresponding to each of the vertical signal lines VLIN. Accordingly, if MOS transistor TS4 is on, negative feedback is applied to COMP 64.

The output end of COMP 64 and the source of MOS transistor TS4 are connected to a latch circuit 70.

<About Latch Unit 33>

The latch unit 33 includes (n+1) latch circuits 70 provided for the vertical signal lines VLIN in a one-to-one correspondence. The digital signals read from (m+1) pixels connected to vertical signal line VLIN1 and digitized at the ADC unit 32 are latched in the latch circuit 70. That is, the latch circuit 70 corresponding to vertical signal line VLIN1 is provided in front of COMP 64. The same holds true for vertical signal lines VLIN2 to VLIN(n+1). Each of the latch circuits 70 can latch 10-bit data. The 10-bit digital signal latched in the latch circuit 70 is output via the ISP 14 by the operation of the shift register 34 (not shown). The 10-bit digital signal transferred from the latch unit 33 to the ISP 14 is the video signals obtained by the pixels 40 arranged on a single horizontal line perpendicular to vertical signal lines VLIN1 to VLIN(n+1). That is, the latch unit 33 transfers collectively to the ISP 14 the video signals read from (n+1) pixels 40 arranged in the horizontal direction perpendicular to the vertical signal lines VLIN.

<Read Operation of Sensor Core Unit 19>

Next, a read operation of the sensor core unit 19 will be explained. A read operation will be explained, focusing on a pixel 40 arranged on the first horizontal line perpendicular to the vertical signal lines VLIN and connected to vertical signal line VLIN1.

First, in a state where the pixel unit 30 are not exposed to any light at all (hereinafter, referred to as a dark period), after a dark-period output clamp voltage is raised by the reference voltage generator circuit 18, the dark-period output clamp voltage is kept at a specific value. The reason for this is to set the voltage generated by the reference voltage generator circuit 18 in the dark period at a dark-period reference level to cause the 10-bit digital output corresponding to the image received by the photodiode PD to always have a specific offset value. The voltage generated in the dark period corresponds to, for example, black if it is expressed in color. The 10-bit digital output involves subjecting the video signals read from the pixels 40 by the ADC unit 32 to 10-bit analog-to-digital conversion and causing the sensor core unit 19 to output a 10-bit digital signal. Since switch signal S2 is high, MOS transistor TS2 is constantly on. Therefore, the capacitor element 51 is charged to the dark-period output clamp voltage. A period from when the reference voltage generator circuit 18 starts to raise the dark-period output clamp voltage until the dark-period output clamp voltage is being output is referred to as a dark-period output clamp period. A period from when the dark-period output clamp voltage has risen until the dark-period output clamp voltage is held at a specific value is referred to as a dark-period output clamp voltage retention period.

Furthermore, a voltage generated by the reference voltage generator circuit 18 from when the dark-period output clamp voltage is reset until the triangular-wave reference voltage VREF has started to rise and from when the triangular-wave reference voltage VREF is reset until the dark-period output clamp voltage has started to rise is referred to as a VREF reset voltage. The reset of the dark-period output clamp voltage means that the voltage in the dark-period output clamp voltage retention period falls and the reference voltage generator circuit 18 outputs the lowest-level voltage. In other words, the lowest-level voltage is the value at the end of the dark-period output clamp period. The reset of the triangular-wave reference voltage VRFEF means that the triangular-wave reference voltage VREF is dropped by the reference voltage generator circuit 18 to terminate analog-to-digital conversion at the ADC unit 32 and the reference voltage generator circuit 18 outputs the lowest-level voltage. The dark-period output clamp voltage at the time of resetting will be explained later.

Next, to read the signals from the pixels 40 arranged on the first horizontal line perpendicular to the vertical signal lines VLIN and connected to vertical signal line VLIN1, signal ADRES1 is changed from the low to high, causing the source follower circuit composed of MOS transistor Tb and MOS transistor TL to operate.

Next, before the charge obtained by photoelectric conversion at the photodiode PD for a specific period is read, noise signals, including dark current in the detection unit N1 are removed as noise signal. To do this, a detection unit reset pulse RESET1 is changed from the low to high. This causes MOS transistor Tc to switch to the on state, which sets the potential of the detection unit N1 to the voltage VDD. Then, a reset level corresponding to the voltage VDD is output onto vertical signal line VLIN1. The reset level is a level corresponding to the potential when there is no charge in the detection unit N1 serving as a voltage reference.

At this time, the ST 17 changes the switch signals S1 to S4 from the low to high, thereby not only setting the analog-to-digital conversion level in COMP 63 and COMP 64 of the ADC unit 32 but also charging the capacitor element 50 to the reset level read onto vertical signal line VLIN1 in addition to the dark-period output clamp voltage. The reset level is accumulated in the capacitor element 50 the instant that switch signal S3 is changed from the high to low. Setting the analog-to-digital conversion level means setting an input threshold voltage that causes MOS transistors TS3 and TS4 to change the outputs of COMP 63 and COMP 64 from the low to high or from the high to low.

Next, the ST 17 changes switch signal S1 from the high to low and then changes signal READ1 from the low to high, thereby turning on MOS transistor Td, which reads a voltage corresponding to the charge accumulated at the photodiode PD into the detection unit N1. At this time, a video signal (a voltage corresponding to the charge+a reset level corresponding to the voltage VDD) is read onto vertical signal line VLIN1. Then, after signal READm is changed from the high to the low, switch signal S3 is kept low, switch signal S4 is changed from the high to the low, and switch signal S1 is changed from the low to the high. Switch signal S2 is always kept high. Then, switch signal S1 is changed from the low to the high, thereby charging the capacitor element 51 to the voltage (the voltage corresponding to the charge+the reset level corresponding to the voltage VDD) read onto vertical signal line VLIN1 in addition to the dark-period output clamp voltage. Then, switch signal S1 is changed from the high to the low, causing the capacitor element 51 to hold the voltage (the dark-period output clamp voltage+the voltage corresponding to the charge+the reset level corresponding to the voltage VDD). The input impedance of the capacitor element 50 is higher than that of the capacitor element 51. Consequently, the capacitor element 50 holds only the potential (the dark-period output clamp voltage+the reset level corresponding to the voltage VDD).

Next, after resetting the dark-period output clamp voltage, the reference voltage generator circuit 18 increases the amplitude of the triangular-wave reference voltage VREF. The ADC unit 32 converts the video signal into a digital signal using the threshold voltage of COMP 63. Specifically, the reference voltage generator circuit 18 increases the amplitude of the triangular-wave reference voltage VREF, increasing the triangular waveform from the low level to the high level, which causes COMP 63 and COMP 64 to perform analog-to-digital conversion. At this time, the triangular waveform of the reference voltage VREF is sliced using 10-bit analog-to-digital conversion levels ranging from level 0 to level 1023. Each analog-to-digital conversion level is determined by a 10-bit counter. Here, let the smallest unit when the triangular waveform is sliced using 1024 levels be one LSB ( 1/1024). Here, 64 LSB corresponds to the dark-period output clamp voltage and to the dark-period output clamp voltage at the time of resetting, that is, the VREF reset voltage corresponds to 0 LSB. The polarity of the voltage (the dark-period output clamp voltage+the reset level corresponding to the voltage VDD) to which the capacitor element 50 has been charged is the opposite of that of the voltage (the voltage corresponding to the charge+the dark-period output clamp voltage+the reset level corresponding to the voltage VDD) to which the capacitor element 51 has been charged. Consequently, the charge is equal to (voltage of capacitor 51−voltage of capacitor element 50). Therefore, the dark-period output clamp voltage and reset level are cancelled, causing only the video signal of the capacitor element 51 to be virtually subjected to analog-to-digital conversion. The operation of removing the dark-period output clamp voltage and reset level is referred to as a noise cancellation (CDS) operation. The CDS operation means correlation double sampling operation.

Then, the digital signal obtained at the ADC unit 32 is held in the latch circuit 70. The same read operation is carried out on a second to an (n+1)-th horizontal line perpendicular to the vertical signal lines VLIN. Thereafter, the video signals read from the pixels 40 arranged on the first horizontal line perpendicular to the vertical signal line VLIN are output from the sensor core unit 19 to the ISP 14 according to the operation of the horizontal shift register 34 as described above. Hereinafter, the same read operation is carried out on up to an (m+1)-th horizontal line perpendicular to the vertical signal lines VLIN.

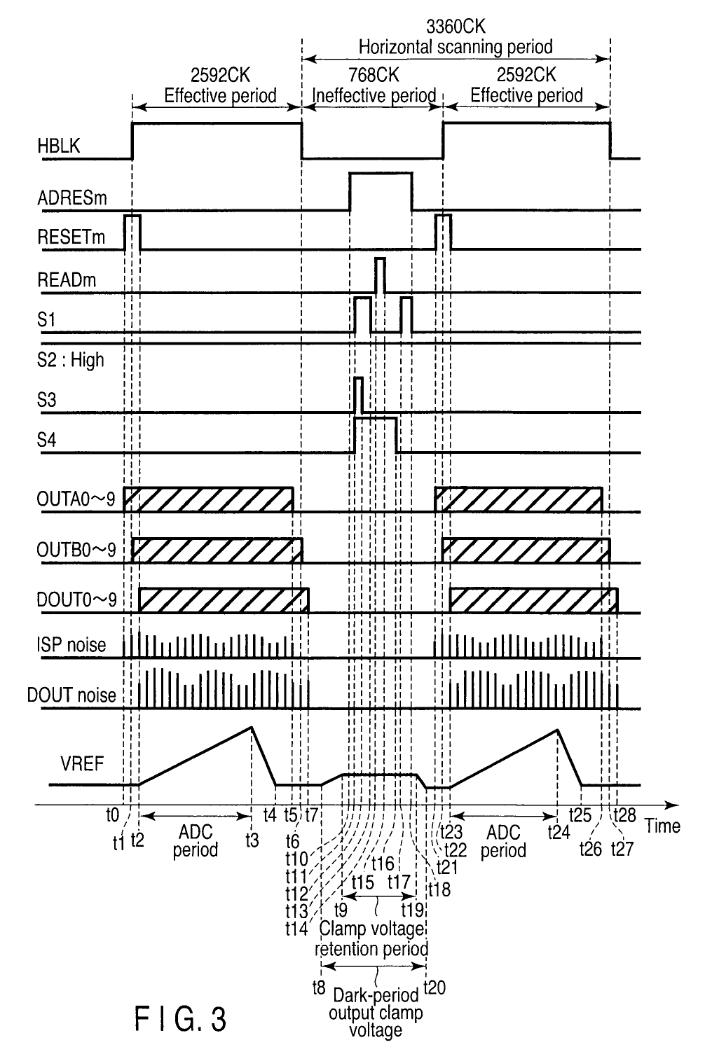

Hereinafter, the operation of outputting the video signal received by the solid-state imaging device 1 of the first embodiment to the outside will be explained using FIG. 3. FIG. 3 is a timing chart showing the operation of various parts of the configuration in outputting the video signals read from the pixels 40 on an m-th horizontal line perpendicular to the vertical signal lines VLIN in the solid-state imaging device 1 of the first embodiment. The solid-state imaging device 1 of the first embodiment operates in synchronization with an internal clock generated by the VCOPLL 10. There is a vertical synchronizing pulse (signal ADRES, signal RESET, signal READ) corresponding to the timing of reading the charge from the pixel unit 30. There is also a horizontal synchronizing pulse corresponding to the operation timing with which the latch unit 33, ISP 14, and DOUT output the read video signal as signal OUTA, signal OUTB, and signal DOUT, respectively. The vertical synchronizing pulse has a vertical flyback period and a vertical scanning period. The horizontal synchronizing pulse has a horizontal flyback period and a horizontal scanning period. In the first embodiment, explanation will be given, focusing only on the horizontal scanning period. The horizontal scanning period is divided into an ineffective period when the latch unit 33, ISP 14, and DOUT 15 output no video signal and an effective period when they output the video signals. Signal HBLK is made low during the ineffective period and high during the effective period. In the first embodiment explained below, the period when signal OUTB is output is assumed to be an effective period. Hereinafter, a case where the TG 16 sets a horizontal scanning period at 3360 clocks (hereinafter, referred to as “CK”), an ineffective period at 768 CK, and an effective period at 2592 CK will be explained as an example.

First, since signal HBLK is made low at time t0 to eliminate a leak current in the detection unit N1, the ST 17 changes signal RESETm from the low to the high. Then, at time t1, signal HBLK is changed from the low to the high. Then, at time t2, the ST 17 changes signal RESETm from the high to the low. As described above, the TG 16 controls various signals to the ST 17. During the period from time t0 to time t7, the video signal read from an (m−2)-th horizontal line perpendicular to the vertical signal lines VLIN and digitized is output from the latch unit 33, ISP 14, and DOUT 15 as signal OUTA, signal OUTB, and signal DOUT, respectively. Then, at time t2, to digitize the video signals read from the (n+1) pixels 40 arranged on an (m−1)-th horizontal line perpendicular to the vertical signal lines VLIN, the reference voltage generator circuit 18 generates a triangular-wave reference voltage VREF. Thereafter, the reference voltage generator circuit 18 increases the amplitude of the triangular-wave reference voltage VREF until time t3. Then, at time t3, to terminate the analog-to-digital conversion of the video signals read from the pixels 40 arranged on the (m−1)-th horizontal line perpendicular to the vertical signal lines VLIN, the reference voltage generator circuit 18 stops outputting the triangular-wave reference voltage VREF. At time t4, the reference voltage VREF makes a VREF reset voltage. As described above, a period from time t1 to time t6 when the ISP 14 outputs signal OUTB is assumed to be an effective period. From time t2 to time t7, the DOUT 15 outputs the video signal as signal DOUT to the outside.

Then, at time t6, when the ISP 14 has finished outputting the video signal as signal OUTB subjected to the video signal process, signal HBLK is changed from the high to the low.

Specifically, at time t6, the effective period is changed to an ineffective period. The reference voltage generator circuit 18 generates a dark-period output clamp voltage at time t8 and keeps the value of the dark-period output clamp voltage constant at time t9. At time t10, the ST 17 changes signal ADRESm from the low to the high to select an m-th horizontal line perpendicular to the vertical signal lines VLIN. Then, at time t11, the ST 17 changes switch signals S1, S2, S4 from the low to the high. As described above, switch signal S2 is constantly high. Therefore, MOS transistor TS2 is constantly on. This causes the capacitor element 50 to be charged to a reset level corresponding to the voltage VDD in addition to the dark-period output clamp voltage. At time t12, the ST 17 changes switch signal S3 from the high to the low. As a result, the analog-to-digital conversion level of COMP 63 is set. Then, at time t13, the ST 17 changes switch signal S1 from the high to the low, thereby keeping the potential of the capacitor element 50 at a voltage (the reset level corresponding to the voltage VDD+the dark-period output clamp voltage).

Then, to read the charge accumulated in the photodiodes PD of the pixels 40 arranged on the m-th horizontal line perpendicular to the vertical signal lines VLIN onto the vertical signal line VLIN, the ST 17 changes signal READm from the low to the high at time t14. This causes the voltage (the voltage corresponding to the charge+the reset level corresponding to the voltage VDD) to be read onto the vertical signal lines VLIN via MOS transistor Tb. Thereafter, the ST 17 changes signal READm from the high to the low at time t15 and switch signal S1 from the low to the high at time t17. This causes the voltage (the voltage corresponding to the charge+the reset level corresponding to the voltage VDD) to pass through MOS transistor TS1, thereby charging the capacitor element 51 to this voltage in addition to the dark-period output clamp voltage. At time t16, switch signal S4 is changed from the high to the low. This sets the analog-to-digital conversion level of COMP 64. Then, at time t18, the ST 17 changes signal ADRESm from the high to the low and switch signal S1 from the high to the low. The reason for this is to prevent the voltage corresponding to the newly read charge to vertical signal lines VLIN from being transferred to the CDS 31, ADC unit 32, and latch unit 33. The period from time t12 to time t18 is referred to as the CDS period. At time t19, the dark-period output clamp voltage output from the reference voltage generator circuit 18 is reset. At time t20, the dark-period output clamp voltage is set as a VREF reset voltage.

At time t21, to read the charge from the pixels 40 arranged on an (m+1)-th horizontal line perpendicular to the vertical signal lines VLIN, signal RESET(m+1) is changed from the low to the high. Then, at time t23, signal REST(m+1) is changed from the high to the low.

In the period from time t21 to time t26, the 10-bit digital signal output from the latch unit 33 is input as signal OUTA to the ISP 14 according to the operation of the shift register 34. The signal output as signal OUTA is the video signal read from the pixels 40 arranged on the (m−1)-th horizontal line perpendicular to the vertical signal lines VLIN and digitized using the triangular-wave reference voltage VREF in the period from time t2 to time t3. Then, the ISP 14 subjects the digital signals supplied from the latch unit 33 to the aforementioned processes in the order in which the ISP received the signals and outputs the processed 10-bit digital signal as signal OUTB to the DOUT 15. That is, the ISP 14 subjects the video signals transferred as signal OUTA from the latch unit 33 collectively to a video signal process. Then, in the period from time t22 to time t27, the ISP 14 inputs the 10-bit digital signal subjected to the video signal process as signal OUTB to the DOUT 15. Thereafter, in the period from time t23 to time 28, the 10-bit digital signal output from the DOUT 15 is output from the solid-state imaging device 1 as signal DOUT.

Then, during the interval from time t23 to time t24 in the effective period, the video signals read from the pixels 40 arranged in the m-th horizontal line perpendicular to the vertical signal lines VLIN are digitized using the triangular-wave reference voltage VREF. The digitized video signal is latched in the latch circuit 70 and, in the next effective period, output to the ISP 14 by the operation of the shift register 34.

When time t27 has passed, the effective period is changed to an ineffective period. That is, even in an ineffective period after time t27, the operation is carried out.

### Effect of the Embodiment

With the configuration of the first embodiment, the effect described in item (1) below will be obtained.

(1) The Operation Reliability can be Improved (Part 1)

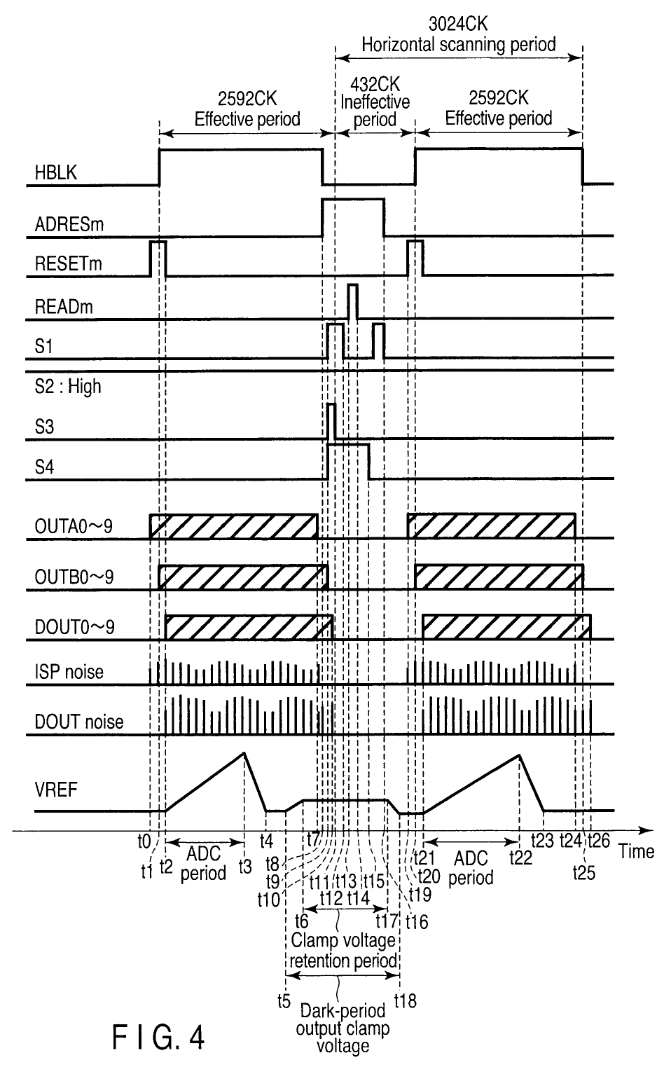

The effect of the solid-state imaging device 1 according to the first embodiment will be explained in comparison with a conventional equivalent. FIG. 4 is a timing chart for the operation of various parts of a conventional solid-state imaging device 1. An explanation of parts in FIG. 4 common to those in FIG. 3 will be omitted. In the configuration of the solid-state imaging device 1 in each of the first embodiment and the conventional equivalent, a block having the same function will be explained using the same reference symbols.

As shown in FIG. 4, a dark-period output clamp voltage is raised by the reference voltage generator circuit 18 at time t5. Then, in the period from time t6 to time t17, the reference voltage generator circuit 18 keeps constant the value of the dark-period output clamp voltage. Then, at time t17, the reference voltage generator circuit 18 causes the dark-period output clamp voltage to start to drop. At time t18, the dark-period output clamp voltage makes a VREF reset voltage. That is, the reference voltage generator circuit 18 starts to output the dark-period output clamp voltage in the period from time t0 to time t10 during which the latch unit 33, ISP 14, and DOUT 15 output signal OUTA, signal OUTB, and signal DOUT, respectively. Signal OUTA, signal OUTB, and signal DOUT in the period from time t0 to time t10 are the video signals read from the pixels 40 arranged on the (m−2)-th horizontal line perpendicular to the vertical signal lines VLIN.

That is, in the conventional configuration, the dark-period output clamp period overlaps with the effective period. Specifically, the operation of reading the pixels 40 arranged on the m-th horizontal line perpendicular to the vertical signal lines VLIN explained above overlaps with the timing in the effective period. In the conventional solid-state imaging device 1, too, the above-described read operation is further performed on the pixels 40 arranged on the (m+1)-th horizontal line perpendicular to the vertical signal lines VLIN.

Accordingly, the conventional solid-state imaging device 1 has the following problem. When the ISP 14 subjects the 10-bit digital signal supplied as signal OUTA from the latch unit 33 to the video signal process, it generates noise (hereinafter, referred to as ISP noise). Even after time t5 when the dark-period output clamp voltage is output, the ISP 14 generates ISP noise. In particular, when the video signal process of signal OUTA is terminated, the ISP 14 generates very high ISP noise. As shown in FIG. 4, with the operation timing of the conventional solid-state imaging device 1, signal OUTA has stopped at time t7 in the dark-period output clamp period. That is, the video signal process of signal OUTA by the ISP 14 has been terminated.

Like the ISP 14, the DOUT 15 also generates noise (hereinafter, referred to as DOUT noise) when outputting signal DOUT. In particular, when the output of signal DOUT is terminated, very big DOUT noise is generated. With the operation timing of the conventional solid-state imaging device 1, the output of signal DOUT has been stopped at time t10 in the dark-period output clamp period.

Then, as described above, the 10-bit digital signal corresponding to the voltage of the charge is processed at the ISP 14. Thereafter, the resulting signal is output from the DOUT 15, which generates the ISP noise and DOUT noise. Then, the ISP noise and DOUT noise are mixed with the dark-period output clamp voltage.

The magnitude of each of the ISP noise and DOUT noise varies according to the charge obtained by causing the photodiode PD to photoelectrically convert the light received by the pixels 40. That is, the greater a change in the intensity of the video signal, the bigger the ISP noise and DOUT noise. Since the ISP noise and DOUT noise vary with the video signal, they are random noise. The DOUT 15 has an increased driver size to drive a high external load. Accordingly, the amount of DOUT noise at the output having, for example, a 4-mA drive capability is about twice the ISP noise generated by the ISP 14. Accordingly, when a low-luminance subject is photographed with the solid-state imaging device 1, the dark-period output clamp voltage drops.

In contrast, when a high-luminance subject is photographed, the voltage of the video signal of the subject becomes the highest. That is, in this case, a change in the intensity of the video signal is small. As a result, most of MOS transistors in the ISP 14 that subjects the 10-bit digital signal converted at the ADC unit 32 to the video signal process and most of the MOS transistors provided in front of the output end of the DOUT 15 remain in the on state. That is, DOUT noise in the MOS transistors provided in front of the output end at which the DOUT 15 outputs signal DOUT becomes lower. ISP noise in the ISP 14 also becomes lower. Since the amount of ISP noise and DOUT noise mixing with the dark-period output clamp voltage becomes smaller than when the low-luminance subject was photographed, the dark-period output clamp voltage becomes higher than the dark-period output clamp voltage at the low luminance. In particular, when the ISP noise and DOUT noise have been produced in the rising period of the dark-period output clamp voltage, a change in each of the dark-period output clamp voltages becomes larger. A change in each of the dark-period output clamp voltages becomes larger is the period from time t5 to time t6 in FIG. 4.

Not only when ISP noise and DOUT noise are stopped but also when they start, the noise becomes bigger. Specifically, even when ISP noise and DOUT noise start in the dark-period output clamp period, the ISP noise and DOUT noise gets mixed with the dark-period output clamp voltage, resulting in a fluctuation in the dark-period output clamp voltage.

As described above, a fluctuation in the dark-period output clamp voltage is caused by the mixing of very big ISP noise or DOUT noise with the dark-period output clamp voltage or by the production of neither DOUT noise nor ISP noise. That is, for example, when the dark-period output clamp voltage varies on a single image, this produces streaking noise.

In this respect, with the operation timing of the solid-state imaging device 1 of the first embodiment, the generation of the streaking noise can be suppressed. In the solid-state imaging device 1 of the first embodiment, the timing with which the latch unit 33, ISP 14, and DOUT 15 finish outputting the video signal as signal OUTA, signal OUTB, and signal DOUT, respectively, is shifted from the timing with which the dark-period output clamp voltage rises. That is, as shown in FIG. 3, with the timing with which the reference voltage generator circuit 18 generates a dark-period output clamp voltage, none of signal OUTA, signal OUTB, and signal DOUT output from the latch unit 33, ISP 14, and DOUT 15, respectively, is stopped. As for signal OUTA, the timing with which the ISP 14 carries out the video signal process neither starts nor ends. Therefore, big noise generated on termination as in the conventional equivalent will never get mixed with the dark-period output clamp voltage. Therefore, even if a subject where low-luminance parts and high-luminance parts are mixed is photographed, a variation in the magnitude of the dark-period output clamp voltage can be suppressed, which enables the generation of streaking noise to be avoided. Moreover, with the operation timing of the solid-state imaging device 1 of the first embodiment, signal OUTA, signal OUTB, and signal DOUT neither start nor end in the dark-period output clamp period. That is, neither ISP noise nor DOUT noise gets mixed with the dark-period output clamp voltage.

If signal OUTA, signal OUTB, and signal DOUT are output continuously in the period when the dark-period output clamp voltage is generated, each operation timing need not be shifted. That is, in the period from when the dark-period output clamp voltage rises until the dark-period output clamp voltage has fallen and the value of the dark-period output clamp voltage has reached the VREF reset voltage, if signal OUTA, signal OUTB, and signal DOUT are output continuously without stop in the middle, it may be acceptable. The reason for this is that ISP noise and DOUT noise are bigger at the beginning and at the end than noise generated as a result of the execution of the video signal process at the ISP 14 or noise generated when the solid-state imaging device 1 outputs the signal. That is, it is desirable that the timing with which ISP noise and DOUT noise are generated should be shifted from the timing with which the dark-period output clamp voltage is generated. However, since they are negligible noise, the timing with which ISP noise and DOUT noise are generated may overlap with the timing with which the dark-period output clamp voltage is generated, provided that the generation of them is neither stopped nor started in the middle.

The length of each of the horizontal scanning period, effective period, and ineffective period set by the TG 16 is not limited to the aforementioned example. That is, the number of effective pixels of the digital signal output at the output end by the solid-state imaging device 1 of the first embodiment is decreased, which enables the number of digital signals output in the effective period to be decreased. That is, the length of the effective period is decreased, with the length of the horizontal scanning period kept unchanged, which enables the ineffective period to be made longer. For example, the pixels 40 are subjected to a ½ thinning-out operation, with the result that the ineffective period is 2064 CK and the effective period is 1296 CK for a horizontal scanning period of 3360 CK. Moreover, the pixels 40 are subjected to a ¼ thinning-out operation, with the result that the ineffective period is 2662 CK and the effective period is 698 CK for a horizontal scanning period of 3360 CK.

The thinning-out operation means, for example, if the size is ¼, a video signal is selected from the outputting pixels 40 at intervals of 4 pixels. The thinning-out operation is carried out in both of the horizontal and vertical directions. This decreases the number of output pixels as compared with the number of effective pixels the solid-state imaging device 1 has. However, a higher-speed operation in frames can be carried out.

<Modification>

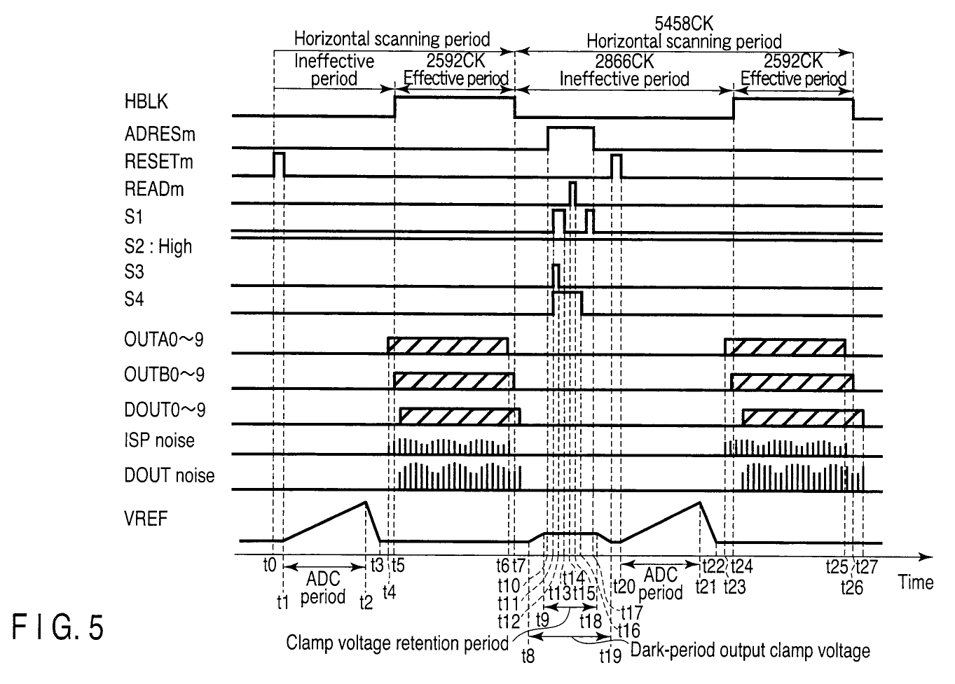

FIG. 5 is a timing chart for the operation of various parts of the configuration in causing the DOUT 15 to output the video signals read from the pixels 40 on the m-th horizontal line perpendicular to the vertical signal lines VLIN according to a modification of the solid-state imaging device 1 of the first embodiment. FIG. 5 is such that, in FIG. 3, the operation timing is shifted so that the analog-to-digital conversion of a video signal performed by the ADC unit 32 in an effective period may be performed in an ineffective period. That is, in the ineffective period, not only does the reference voltage generator circuit 18 generate a dark-period output clamp voltage, but also generates a triangular-wave reference voltage VREF to the ADC unit 32 to perform analog-to-digital conversion. The operation timing of analog-to-digital conversion by the ADC unit 32 is controlled by the ST 17 that controls the operation timing of the sensor core unit 19 and by the TG 16 that instructs the ST 17 on operation timing.

In the explanation below, the parts common to the operation timing of FIG. 3 will be omitted. Since the configuration of the first embodiment is the same as that of the solid-state imaging device 1 related to the modification of the first embodiment, explanation will be given using the same reference symbols.

First, to cause not only the reference voltage generator circuit 18 to generate a dark-period output clamp voltage but also to generate a triangular-wave reference voltage VREF to the ADC unit 32 to perform analog-to-digital conversion in the ineffective period, the ineffective period in the horizontal scanning period is made longer than the effective period. Hereinafter, a case where the TG 16 has set the horizontal scanning period at 5458 CK, the ineffective period at 2866 CK, and the effective period at 2592 CK will be explained as an example. That is, the length of the effective period is the same as that of the effective period in the first embodiment. This is a case where the horizontal scanning period is made longer to lengthen the ineffective period. In the horizontal scanning period, let time t0 to time t5 and time t7 to time t24 be ineffective periods and time t5 to time t7 and time t24 to time t26 be effective periods. For convenience sake, suppose the timing with which signal RESETm input to the pixels 40 arranged on the m-th horizontal line perpendicular to the vertical signal lines VLIN goes high is the beginning of the ineffective period, or time t0.

As shown in FIG. 5, in the period from time t0 to time t20, the solid-state imaging device 1 of the modification carries out the operations in the period from time t0 to time t23 of FIG. 3.

Then, the reference voltage generator circuit 18 generates a triangular-wave reference voltage VREF in the period from time t20 to time t21. Then, at time t22, the triangular-wave reference voltage VREF makes a VREF reset voltage. That is, the reference voltage generator circuit 18 generates a triangular-wave reference voltage VREF for the video signal read from the pixels 40 arranged on the (m−1)-th horizontal line perpendicular to the vertical signal lines VLIN, causing the ADC unit 32 to digitize the noise-cancelled video signal. Thereafter, the resulting digital signal is latched in the latch unit 33.

Then, as in the period from time t21 to time t28 of FIG. 3, in the period from time t23 to time t27, the latch unit 33 outputs the video signal read from the pixels 40 arranged on the (m−1)-th horizontal line perpendicular to the vertical signal lines VLIN as signal OUTA to the ISP 14, the ISP 14 outputs the video signal as signal OUTB, and the DOUT 15 outputs the video signal as signal DOUT.

<Effect of the Modification>

The configuration of the modification of the first embodiment produces the effect in the following item (2) in addition to the effect in item (1).

(2) The Operation Reliability can be Improved (Part 2)

Not only a dark-period output clamp voltage but also a triangular-wave reference voltage VREF for analog-to-digital conversion are generated in an ineffective period, making it possible to prevent not only a fluctuation in the dark-period output clamp voltage but also a fluctuation in the triangular-wave reference voltage VREF. With the solid-state imaging device 1 of the modification of the first embodiment, the operation timing with which the latch unit 33, ISP 14, and DOUT 15 output signal OUTA, signal OUTB, and signal DOUT, respectively, is shifted from the operation timing with which the ADC unit 32 digitizes the video signal read from the pixels 40.

This makes it possible to avoid a fluctuation in the triangular-wave reference voltage VREF caused by ISP noise and DOUT noise generated in the video signal process by the ISP 14 or at the time when the DOUT 15 outputs signal DOUT. That is, streaking noise can be suppressed.

Although in FIG. 3, a case where neither signal OUTA, signal OUTB, nor signal DOUT overlaps with the dark-period output clamp period has been explained, at least signal DOUT has only to overlap with no dark-period output clamp period.

### Second Embodiment

Next, a solid-state imaging device according to a second embodiment of the invention and a method of driving the solid-state imaging device will be explained. As in the first embodiment, in the second embodiment, an explanation will be given using a CMOS image sensor as an example. The second embodiment is such that the DOUT 15 outputs signal DOUT by a serial differential method (DOUT+/DOUT−) in the first embodiment. That is, the DOUT 15 includes a parallel-to-serial converter (not shown) and a differential output circuit. The differential output circuit is composed of an operational amplifier. The parallel-to-serial converter converts a video signal supplied as a parallel signal from the ISP 14 into a serial signal and supplies the serial signal to the operational amplifier. Signals which are the same in amplitude and opposite in phase are input to the operational amplifier. Specifically, the parallel-to-serial converter transmits signals equal in amplitude and opposite in phase via signal line DOUT+ and signal line DOUT−. The signals are then input to the operational amplifier. In the differential output circuit, the power supply fluctuates only slightly and output noise is hardly generated. The reason for this is that, even if noise is included in each of signal lines DOUT+ and DOUT−, they cancel each other out because they are opposite in phase. Since the configuration of the solid-state imaging device 1 of the second embodiment is the same as that of the first embodiment, its explanation will be omitted.

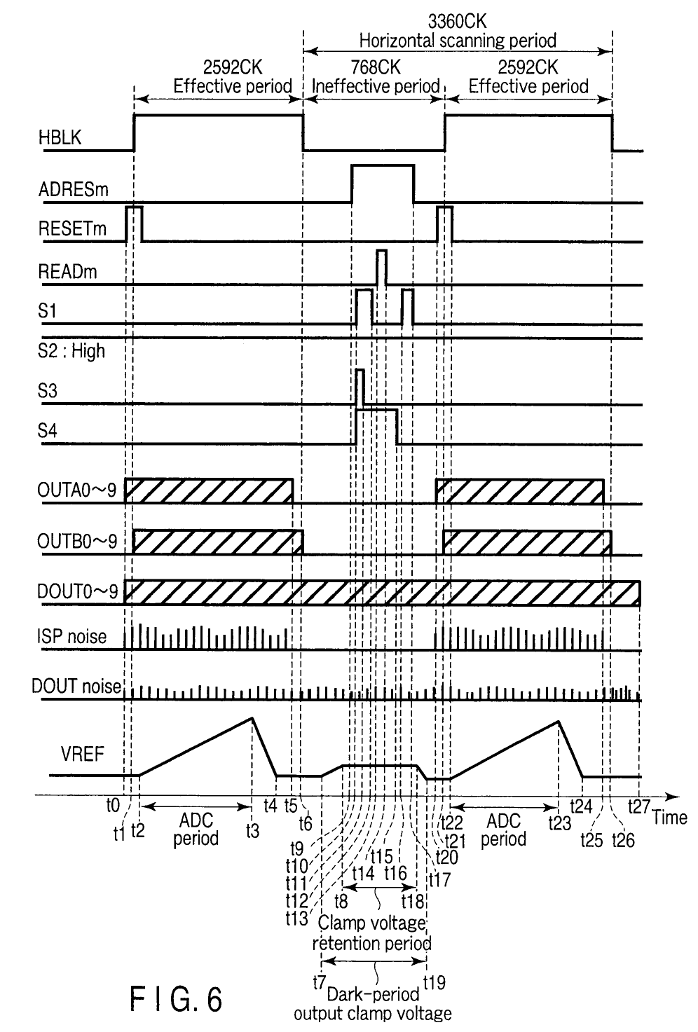

Hereinafter, a read operation of the solid-state imaging device 1 of the second embodiment will be explained using FIG. 6. FIG. 6 is a timing chart for the operation timing of various parts of the configuration in causing the DOUT 15 to output the video signal read from the pixels 40 on the m-th horizontal line perpendicular to the vertical signal lines VLIN according to a modification of the solid-state imaging device 1 of the second embodiment. An explanation of parts in FIG. 6 common to those in FIG. 3 will be omitted.

As shown in FIG. 6, signal DOUT serially output from the DOUT 15 is constantly output from the solid-state imaging device 1, regardless of an effective period or an ineffective period. That is, even in a dark-period output clamp period and an analog-to-digital conversion period, the DOUT 15 outputs signal DOUT. As shown in FIG. 6, the DOUT 15 outputs a video signal as signal DOUT, generating DOUT noise. Unlike in parallel output, in serial output, not all of the 10-bit video signal transferred from the latch unit 33 is output simultaneously. The 10-bit video signal is output, beginning with the first bit. For this reason, DOUT noise in the serial output of the solid-state imaging device 1 of the second embodiment is lower than that in the parallel output of the first embodiment.

### Effect of the Second Embodiment

The configuration of the second embodiment produces not only the effect in item (1) of the first embodiment but also the following effect.

(3) The Operation Reliability can be Improved (Part 3)

With the solid-state imaging device 1 of the second embodiment, DOUT noise generated when the DOUT 15 outputs a video signal as signal DOUT is lower than that in parallel output. The reason for this is that a fluctuation in the current when the solid-state imaging device 1 outputs a signal is smaller than that in parallel output. Therefore, even if signal DOUT is constantly output, a fluctuation in the dark-period output clamp voltage and that in the triangular-wave reference voltage VREF are small. That is, streaking noise caused by fluctuations in these voltages can be suppressed.

<Modification>

Next, a solid-state imaging device 1 according to a modification of the second embodiment will be explained. Like the modification of the first embodiment, the modification of the second embodiment is such that analog-to-digital conversion is performed in an ineffective period in addition to a dark-period output clamp period. That is, in an ineffective period, the reference voltage generator circuit 18 generates a triangular-wave reference voltage VREF used for analog-to-digital conversion of a video signal. Since the configuration of the solid-state imaging device 1 according to the modification of the second embodiment is the same as that of the solid-state imaging device 1 of the second embodiment, its explanation will be omitted.

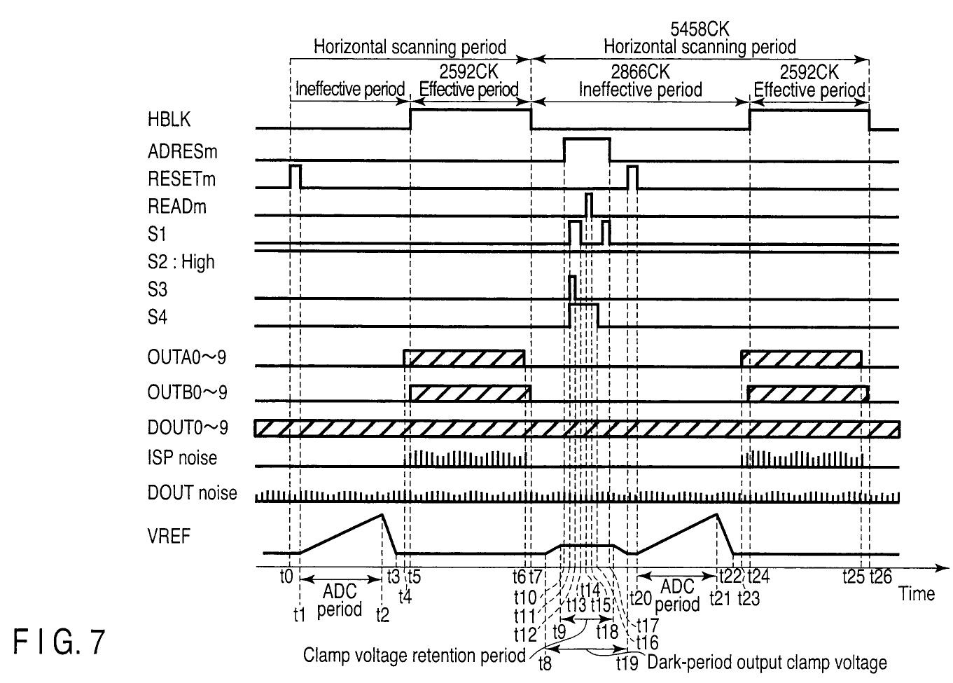

FIG. 7 is a timing chart for the operation timing of various parts of the configuration in causing the DOUT 15 to output the video signal read from the pixels 40 on the m-th horizontal line perpendicular to the vertical signal lines VLIN according to the modification of the solid-state imaging device 1 of the second embodiment.

As in the modification of the first embodiment, FIG. 7 is such that, in the second embodiment, the operation timing is shifted so that analog-to-digital conversion performed by the ADC unit 32 in an effective period may be performed in an ineffective period. That is, in the ineffective period, not only does the reference voltage generator circuit 18 generate a dark-period output clamp voltage, but also the operation timing by analog-to-digital conversion is used. Since the operation timing is shared with the operation timing of FIG. 6 explained in the second embodiment, its explanation will be omitted. The operation timing of analog-to-digital conversion by the ADC unit 32 is controlled by the ST 17 that controls the operation timing of the sensor core unit 19 and the TG 16 that instructs the ST 17 on operation timing.

<Effect of the Modification>

The configuration of the modification of the second embodiment produces not only the effects in items (1) and (3) but also the following effect in item (4).

(4) The Operation Reliability can be Improved (Part 4)

As in the modification of the first embodiment, in the modification of the second embodiment, analog-to-digital conversion by the ADC unit 32 in an ineffective period enables ISP noise to be prevented from getting mixed with a triangular-wave reference voltage VREF used for analog-to-digital conversion. Accordingly, the triangular-wave reference voltage VREF fluctuates according to ISP noise less frequently. Since DOUT noise is low as described above, signal DOUT may be output even in the dark-period output clamp period and the period when the ADC unit 32 performs analog-to-digital conversion as in the modification of the first embodiment.

While in the first embodiment, a period when the ISP 14 outputs signal OUTB is referred to as an effective period, it may be a period when the DOUT 15 outputs signal DOUT to the outside.

In the first and second embodiments, the timing has to be shifted so as to prevent signal OUTA transferred from the latch unit 33 to the ISP 14 and signal DOUT output from the DOUT 15 from not only ending but also starting in the dark-period output clamp period. The reason is that ISP noise and DOUT noise become very big not only at the end but also at the start of the signal, causing the values of the dark-period output clamp voltage and the triangular-wave reference voltage VREF to vary.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A method of driving a solid-state imaging device, the method comprising:
causing a plurality of pixel units to output a reset signal serving as a first reference level of a video signal to signal lines according to a reset voltage, the video signal being output in units of two or more of the pixel units simultaneously to two or more of the signal lines;
generating a dark-period output clamp voltage serving as a second reference level of the video signal;
obtaining a first addition result by adding the reset signal output to the signal lines and the dark-period output clamp voltage;
after the reset signal is output to the signal lines, causing the pixel units to output the video signal to the signal lines according to the reset voltage and the charge obtained by photoelectric conversion;
obtaining a second addition result by adding the video signal output to the signal lines and the dark-period output clamp voltage;
calculating the difference between the first addition result and the second addition result;
digitizing the difference and transferring the result of digitization to a video processing unit and
causing the video processing unit to carry out a signal process using the transferred result of digitization, the video processing unit terminating and starting the signal process in units of the pixel unit in a period when the dark-period output clamp voltage is not generated.

2. The method according to claim 1, further comprising: causing the video processing unit to output the result of carrying out the signal process to the outside via a data output unit,
wherein the data output unit finishes and starts outputting the result in a period when the dark-period output clamp voltage is not generated.

3. The method according to claim 1, wherein the video processing unit terminates and starts the signal process in units of the pixel unit in a period when the dark-period output clamp voltage is not generated and the digitization is not performed.

4. The method according to claim 1, wherein the data output unit finishes and starts outputting the result in a period when the dark-period output clamp voltage is not generated and the digitization is not performed.

5. The method according to claim 2, wherein the video processing unit outputs in parallel the result of carrying out the signal process to the data output unit, and
the data output unit converts the parallel output supplied from the video processing unit into serial output.

6. The method according to claim 1, further comprising: causing a latch circuit to latch the result of digitization; and
causing the latch circuit to transfer the result of digitization to the video processing unit in units of 10 bits.

7. The method according to claim 2, further comprising: causing a control unit to control the length of the period.

8. A method of driving a solid-state imaging device, the method comprising:
causing a plurality of pixel units to output a reset signal serving as a first reference level of a video signal to signal lines according to a reset voltage;
generating a dark-period output clamp voltage serving as a second reference level of the video signal;
obtaining a first addition result by adding the reset signal output to the signal lines and the dark-period output clamp voltage;
after the reset signal is output to the signal lines, causing the pixel units to output the video signal to the signal lines according to the reset voltage and the charge obtained by photoelectric conversion;
obtaining a second addition result by adding the video signal output to the signal lines and the dark-period output clamp voltage;
calculating the difference between the first addition result and the second addition result;
digitizing the difference;
causing a latch circuit to latch the result of digitization; and
causing the latch circuit to transfer the result of digitization to a video processing unit, the latch circuit finishing and starting transferring the result of digitization to the video processing unit in a period when the dark-period output clamp voltage is not generated.

9. The method according to claim 8, further comprising: causing the video processing unit to subject the result of digitization transferred from the latch circuit to a signal process; and
outputting the result of carrying out the signal process to the outside via a data output unit,
wherein the data output unit finishes and starts outputting the result in a period when the dark-period output clamp voltage is not generated.

10. The method according to claim 9, wherein the video signal is output in units of two or more of the pixel units simultaneously to two or more of the signal lines, and
the video processing unit terminates and starts the signal process in units of the pixel unit in a period when the dark-period output clamp voltage is not generated and the digitization is not performed.

11. The method according to claim 8, wherein the data output unit finishes and starts outputting the result in a period when the dark-period output clamp voltage is not generated and the digitization is not performed.

12. The method according to claim 9, wherein the video processing unit outputs in parallel the result of carrying out the signal process to the data output unit, and
the data output unit converts the parallel output supplied from the video processing unit into serial output.

13. The method according to claim 8, wherein the latch circuit transfers the result of digitization to the video processing unit in units of 10 bits.

14. The method according to claim 9, further comprising causing a control unit to control the length of the period.

15. A solid-state imaging device comprising:
a plurality of pixel units which output to individual signal lines a reset signal serving as a first reference level of a video signal according to a reset voltage and the video signal according to the reset voltage and the charge obtained by photoelectric conversion, the video signal being output in units of two or more of the pixel units simultaneously to two or more of the signal lines;
a reference voltage generator circuit which generates a dark-period output clamp voltage serving as a second reference level of the video signal;
a cancellation unit which calculates the difference between a first addition result by adding the reset signal output to the signal lines and the dark-period output clamp voltage and a second addition result by adding the video signal and the dark-period output clamp voltage;
an analog-to-digital converter unit which digitizes the subtraction result;
a latch circuit which latches the result of digitization obtained at the analog-to-digital converter unit; and
a video processing unit which subjects the result of digitization transferred from the latch circuit to a signal process, the video processing unit terminating and starting the signal process in units of the pixel unit in a period when the dark-period output clamp voltage is not generated.

16. The device according to claim 15, further comprising: a data output unit which outputs the result of the video processing unit carrying out the signal process to the outside,
wherein the data output unit finishes and starts outputting the result in a period when the dark-period output clamp voltage is not generated.

17. The device according to claim 15, wherein the video processing unit terminates and starts the signal process in units of the pixel unit in a period when the dark-period output clamp voltage is not generated and the digitization is not performed.

18. The device according to claim 16, wherein the data output unit finishes and starts outputting the result in a period when the dark-period output clamp voltage is not generated and the digitization is not performed.

19. The device according to claim 16, wherein the video processing unit outputs in parallel the result of carrying out the signal process to the data output unit, and
the data output unit converts the parallel output supplied from the video processing unit into serial output.

20. The device according to claim 15, wherein the latch circuit transfers the result of digitization to the video processing unit in units of 10 bits.
